(19) United States
(12) Patent Application Publication
(10) Pub. No.: US 2005/0172027 A1
(43) Pub. Date: Aug. 4, 2005

(54) Management of service level agreements for composite Web services

(76) Inventors: Maria Guadalupe Castellanos, Sunnyvale, CA (US); Fabio Casati, Palo Alto, CA (US); Ming-Chien Shan, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/770,288

(22) Filed: Feb. 2, 2004

(51) Int. Cl. G06F 15/16; G06F 7/00; G06F 17/00; G06F 15/177

(52) U.S. Cl. 709/229; 707/100; 709/222

(57) ABSTRACT

Method and apparatus are disclosed for managing at least one service level agreement (SLA) associated with at least one composite Web service. For each completed process instance, the status data logged in executing the process instance is analyzed to determine whether the process instance satisfied the SLA. The violation/satisfaction data and the logged status data are then used to construct an explanatory decision tree. Each node in the explanatory decision tree represents at least one attribute of the process instances, each branch from a node represents a subset of attribute values of the attribute of the node, and each leaf node indicates a probability value that process instances having attribute values consistent with the attribute values in nodes on a path to the leaf node fail to satisfy the SLA. Data that represents the explanatory decision tree may then be output to explain past violations of SLAs. Other embodiments generate a predictive decision tree that may be used in predicting whether active process instances will violate a SLAs.

### FIELD OF THE INVENTION

The present disclosure generally relates to managing service level agreements for Web services.

### BACKGROUND

Initially, content published on the World Wide Web was in the form of static pages that were downloaded to a user's browser. The browser interpreted the page for display, as well as handling user input to objects such as forms or buttons. Recently, “Web services” have been used to extend the Web's capability to provide dynamic content that is accessible by other programs besides browsers.

Web services are network-based (particularly Internet-based) applications that perform a specific task and conform to a specific technical format. Web services are represented by a stack of emerging standards that describe a service-oriented, application architecture, collectively providing a distributed computing paradigm having a particular focus on delivering services across the Internet.

Generally, Web services are implemented. as self-contained modular applications that can be published in a ready-to-use format, located, and invoked across the World Wide Web. When a Web service is deployed, other applications and Web services can locate and invoke the deployed service. They can perform a variety of functions, ranging from simple requests to complicated business processes.

Web services are typically configured to use standard Web protocols such as Hypertext Transfer Protocol (HTTP), Hypertext Markup Language (HTML), Extensible Markup Language (XML) and Simplified Object Access Protocol (SOAP). HTTP is an application-level protocol commonly used to transport data on the Web. HTML and XML are formatting protocols typically used to handle user input, encapsulate user data, and format output for display. SOAP is a remote procedure call (RPC) and document exchange protocol often used for requesting and replying to messages between Web services.

The use of Web services has made the browser a much more powerful tool. Far from being simple static Web pages, Web services can handle tasks as complex as any computer program, yet can be accessed and run most anywhere due to the ubiquity of browsers and the Internet.

A composite Web service is composed of multiple Web services. For purposes of further discussion herein, a composite Web service is referred to as a Web service, and the constituent Web services of the composite Web service are referred to as Web service components or stages. The composite Web service entails the overall work that is to be performed by the collection of stages. For example, a composite Web service may support the purchase of a piece of equipment, and the stages may handle the submission of a purchase order, parts management, assembly management, delivery management, and payment management.

One or more service level agreements (SLAs) may be associated with a Web service. An SLA defines the quality of service offered by a provider to a customer under a given set of circumstances. For example, an SLA may require that 90% of operations executed between the hours of 9:00 a.m. and 5:00 p.m. be completed within three seconds.

It is essential for service providers to satisfy SLAs. Whether a service provider satisfies its SLAs plays a large part in customers' perceptions of the provider. Furthermore, SLAs may be contractual terms, and failure to satisfy an SLA may be a breach of a contract. Thus, not only may failure to satisfy an SLA result in customer defections, but there may be costs direct incurred from failing to meet contract obligations.

### SUMMARY

The various embodiments of the invention relate to managing service level agreements (SLAs) associated with a composite Web service. An example of a composite Web service is a business process. For each completed process instance, the status data logged in executing the process instance is analyzed to determine whether the process instance satisfied the service level agreement. The violation/satisfaction data and the logged status data are then used to construct a classification model, which in one embodiment may be a decision tree called the explanatory decision tree. Each node in the explanatory decision tree represents at least one attribute of the process instances, each branch from a node represents a subset of attribute values of the attribute of the node, and each leaf node indicates a probability value that process instances having attribute values consistent with the attribute values in nodes on a path to the leaf node fail to satisfy or violate the SLA. Data that represents the decision tree may then be output to explain past violations of the SLA. Classification models may be used to explain patterns of violations of service level agreements in terms of the attributes of Web service process instances and of the attributes of the entities processed by those process instances.

It will be appreciated that various other embodiments are set forth in the Detailed Description and Claims which follow.

### BRIEF DESCRIPTION OF THE DRAWINGS

FIG. 1 is a process flow of an example composite Web service;

FIG. 2 is a functional block diagram that illustrates an example arrangement for managing service level agreements (SLAs) in accordance with various embodiments of the invention;

FIG. 3 is a flowchart of an example process for constructing an explanation model and one or more prediction models in accordance with various embodiments of the invention;

FIG. 4 an example explanation model of the composite Web service of FIG. 1;

FIGS. 5A and 5B illustrate two example decision trees based on two prediction stages from the example composite Web service of FIG. 1;

FIG. 6 is a flowchart of an example process for defining SLAs in accordance with various embodiments of the invention;

FIG. 7 is a flowchart of an example process for explaining violations and satisfactions of an SLA completed process instances in accordance. with various embodiments of the invention; and

FIG. 8 is a flowchart of an example process for predicting a violation of an SLA in accordance with various embodiments of the invention.

### DETAILED DESCRIPTION

Service providers may greatly benefit from the capability of monitoring service level agreement (SLA) violations, understanding why SLAs are not satisfied, and forecasting whether an SLA will be violated. These aspects of SLA management may assist a service provider in correcting or circumventing potential problems. The various embodiments of the present invention provide assistance in managing SLAs. The management techniques described herein provide information on describing what has happened in a Web service relative to compliance to the defined SLAs, information that may be useful in determining why an SLA has been violated, and information that indicates what probably will happen relative to compliance with SLAs.

Generally, status data logged in association with a Web service is examined for violations of SLAs. This SLA violation information may then be used to explain in the aggregate why SLA violations have occurred. In one embodiment, a decision tree is used to explain SLA violations in terms of logged status data of the process instances. The overall processing of a composite Web service from an initial input data set through to completion is referenced herein as a process instance. Each node in the decision tree represents at least one attribute of the process instances, each branch from a node represents a subset of attribute values of the attribute of the node, and each leaf node indicates a probability value that process instances will fail to satisfy the service level agreement for process instances having attribute values consistent with the attribute values in nodes on a path to the leaf node.

In addition to explaining SLA violations, further processing may be performed to predict which SLAs will be violated by active (or “running”) process instances. Each prediction is made in terms of the relative probability that an active process instance will violate an SLA given the process instance's logged status data and how similar process instances have fared, considering only logged status data of the similar process instances up to the current stage of execution of the process instance. The execution of each component of a composite Web service corresponds to a different execution stage of the process instance. In an example embodiment, decision trees are used to formulate and illustrate the predictions.

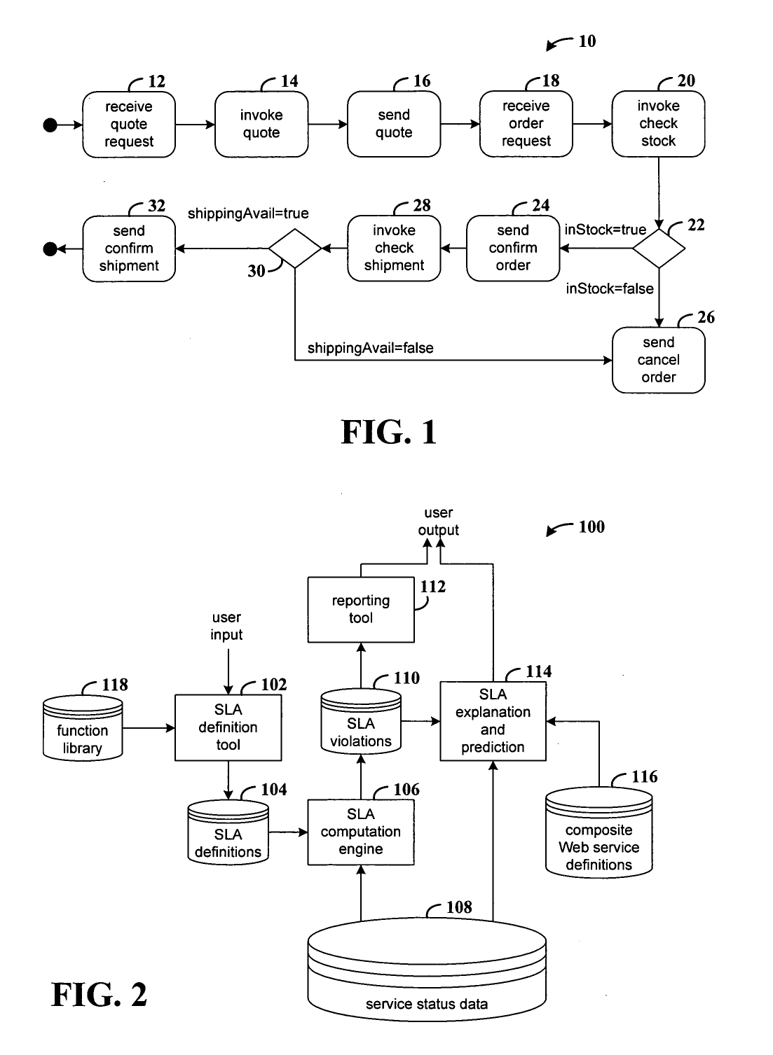

FIG. 1 is a process flow 10 of an example composite Web service. The example relates to supply chain management and is referenced in various portions of the Detailed Description to illustrate various concepts. The composite Web service is named buy_ties and encompasses all operations related to the processing of tie orders placed by customers. It will be appreciated that although the example relates to supply chain management, the various embodiments. of the invention may be applied to composite Web services in other problem domains.

An interface definition informs a customer how to interact with the buy_ties Web service. An abstract specification of the interface is as follows:
in quote_request (product_id, quantity, city)
out quote (quote_#, product_id, quantity, city, price)
in order_request (quote_#)
out confirm_order (order_#, product_id, quantity, city, price)
out cancel_order (order_#)
out confirm_shipment (order_# date)

The prefix, in, indicates that the operation is invoked by the customer, and out indicates that the operation is invoked by the provider. The names of the interface operations, for example, quote_request and names of parameters are self-explanatory. The operations of the interface correspond to different execution stages of the process. The stages that have no clear correspondence to operations of the interface definition are stages performed by the provider and beyond the view of the customer.

The process of FIG. 1 illustrates the various Web service components and therefore, execution stages, involved in performing the composite Web service, buy_ties. At stage 12, the Web service receives a quote request that specifies a product_id, quantity, and city (destination). In response, the provider initiates the invoke quote stage 14, which determines the quoted price for the requested quantity. The send quote stage 16 sends the quote to the customer and includes a quote_# for subsequent use. The next stage 18 commences when the provider receives an order request from the customer. The provider checks the available stock in stage 20, and if sufficient stock is available (decision 22), a confirmation of the order is sent to the customer at stage 24. If there is insufficient stock, the customer is informed that the order is canceled at stage 26. If the requested ties are in stock and after the order confirmation is sent to the customer, the provider invokes the check shipment process in stage 28 to verify whether shipping is available. If no shipping is available (decision 30), then the order is canceled (stage 26). Otherwise, a shipment confirmation is sent at stage 32.

Customers' expectations of the quality of service in initiating the buy_ties service may be codified in one or more SLAs. SLAs may be defined by business persons and formalized for use in an SLA management system by a technical manager of the Web service. Alternatively, a user interface may be adapted to remove the need for technical knowledge and allow the business persons to directly codify the SLAs.

In one embodiment, the metrics underlying SLAs may be codified in structured query language (SQL) statements that can be run on status data logged by the Web service.

SLA is sometimes used as the abbreviated term for an SLA clause. A combination of SLA clauses is referred to as a composite SLA. Each SLA clause specifies a Boolean condition relative to Web service logged status data. For example, a first clause may state that the provider guarantees that the time to deliver ties to customer ABC will not exceed 48 hours from the time the order is received by the provider to the time the goods arrive to the customer, assuming that there is sufficient stock available and shipping is available. A second clause may state that the provider guarantees a response time of 5 minutes from the time that a quote is requested by customer ABC to the time that the provider sends the quote.

Status data logged by the Web service management system (not shown) is used to determine whether the Web service has violated the two example SLA clauses (given above) for a process instance. For each clause there is a corresponding metric that is computed from the logged status data. The SLA clause defines a Boolean condition on the metric that must evaluate to true for the SLA clause to be satisfied. While not shown it will be appreciated that various proprietary or commercially available Web service management systems may be used in coordinating the activities and logging status data for a composite Web service.

For both the first and second clauses the metric is the duration, which is computed over different intervals according to the clause. For the first clause, the duration is computed over the interval that begins at the time at which an order is received (receive order request stage 18) and ends at the time at which a shipment confirmation is sent (send confirm shipment stage 32). Each stage has start_time and end_time parameters, and in the present example, the start_time of the receive order request stage 18 and the end_time of the send confirm shipment stage 32 are used to determine the duration. Example SQL statements for this SLA clause may be specified as:
SELECT N.FLOWINSTANCE_ID
FROM NODE_INSTANCE N1,NODE_INSTANCE N2
WHERE (N2.ENDTIME-N1.STARTTIME)>%THRESHOLD
AND ND1.NODE_id=%NODE1 AND ND2.NODE_id=%NODE2
AND ND1.FLOWINSTANCE_ID=N2.FLOWINSTANCE_ID

%NODE 1 is the identifier of the node corresponding to stage 18 and %NODE2 is the identifier for stage 32. This SQL may be transformed into a more complex formulation required for optimizing the computation of metrics and referencing any additional tables used in the implementation.

For the second clause, the duration is computed on the interval that begins with the start_time of the receive quote request stage 12 and ends with the end_time of the send quote stage 16. The example SQL for the second clause is similar to that shown above for the first clause, except the values of the parameters %NODE1 and %NODE2 are identifiers of stages 12 and 15, respectively.

Once the SLA clauses have been defined, the logged status data of the Web service may be analyzed to determine whether the SLA was satisfied or violated for each process instance by measuring for each process instance the metric called out in each SLA clause. This allows business persons to monitor the quality of service provided to various customers in terms of the SLAs.

SLA clauses may be classified according to several characteristics, and the classification may be used to facilitate SLA definition and management. One way in which SLA clauses may be classified is by the metric that defines the clause. Example metrics include duration, data value, path, count, or resource. An SLA clause that involves the duration generally requires that the time between two stages of the Web service is equal to, less than, or greater than a certain threshold value as in the two example SLA clauses described above.

An SLA clause that involves a data value is a condition on a variable associated with a process instance. For example, this type of SLA clause may require that at least three quality assurance consultants are named for orders for a quantity that exceeds a selected threshold value. Both the number of consultants and the order quantity are data values that may be determined from the logged status data.

An SLA clause that involves a path requires that a process instance takes a given path to execute specific stage(s) of the Web service. For example, an SLA clause may require that certain types of orders are shipped for overnight delivery. This implies that a stage involving overnight shipment must be executed for qualifying orders.

An SLA clause that involves a count requires that a specified stage is activated a specified number of times for each process instance. For example, a quality assurance stage may need to be repeated a certain number of times for orders from certain customers.

An SLA clause that involves a resource requires that a specified stage of the Web service is executed by a specified resource. For example, an SLA clause may require that projects submitted by certain employees be first reviewed by selected team members.

It will be appreciated that SLA clauses may be members of more than. one class. For example, a clause might state that the delivery time for orders having values. greater than $1000 cannot exceed 20 days. This example SLA clause involves both data and duration metrics.

Yet another classification of SLA clauses is whether the clause is general or specific. A general SLA clause involves analyzing the status data logged for many process instances, and a specific SLA clause involves analyzing the status data logged for a single process instance. The previously presented examples relate to specific SLA clauses. A generic SLA clause might state that 95% of all orders should be delivered within 3 days, and no delivery can exceed 30 days.

It will be appreciated that additional classifications are possible depending on the characteristics of the Web service. In addition, SLA classifications may be constructed based on whether the metrics tend to relate more to business-level issues or relate more to technology-related issues. Example business-related issues include the first and second SLA clauses described above. An example technology-related issue might state that each stage in the Web service require no more than 3 seconds to complete during normal business hours.

FIG. 2 is a functional block diagram that illustrates an example arrangement 100 for managing service level agreements (SLAs) in accordance with various embodiments of the invention. The SLAs may be defined via an SLA definition tool 102. The definition tool, which may be a commercially available or proprietary tool, provides the interface through which a user defines the SLAs against which the logged status data of process instances is to be evaluated. The SLA definitions are stored in SLA definition database 104. The SLA computation engine 106 evaluates the Web service status data 108 against the SLAs set forth in the SLA definition database 104. Status data 108 includes the status data logged in association with executing process instances. The data that describes the SLA violations, as determined from the Web service status data 108, is stored as SLA violations 110. Reporting tool 112 is available to report each individual SLA that has been violated along with the process instances that resulted in the violations. SLA explanation and prediction tool 114 computes explanation and prediction models from the SLA violation information 110, Web service status data 108, and definitions 116 of the composite Web service and provides explanations and predictions upon demand.

The SLA definition tool 102 provides the interface through which a user defines the SLAs against which the status data of process instances is to be evaluated. The definitions may be explicitly entered by a user or defined by parameterizing selected functions from function library 118. SLAs specified by a user may be in the form of SQL statements, for example.

To assist in quickly defining SLAs, the function library consists of predefined, parameterizable functions that enable the computation of many SLAs. The functions may be grouped by the class of SLA to which the functions are applicable, which assists the user in quickly identifying the appropriate function to use for a particular SLA clause. For example, one function might be distanceGreaterThan(S1, S2, T). This function returns a list of process instances for which the time elapsed between the completion stage S1 and stage S2 is greater than the threshold T. S1 may assume the special value start, denoting the start of the process instance, and S2 takes the special value end, denoting the completion of the process instance. Many different SLAs that include conditions on the time elapsed between the execution of certain nodes in a process (or on the duration of the entire process) may be specified using this function.

With the function library 118, a user may select a function and specify the parameters that are to be used by the function in evaluating an SLA. The user may, depending on the function, further specify the particular Web service to which and the customer to whom the SLA is to apply.

The SLA definitions are stored in SLA definition database 104. In an example embodiment, the SLA definition database has tables for the constructors that describe the domain, i.e., entities and relationships, as well as tables for the different abstractions of the metrics model underlying the metrics implementation; there is a metric that underlies each SLA. Specifically, there are tables for the metrics, mappings, meters and contexts. The abstractions support sharing of mappings and the polymorphism of the metrics, which are mechanisms used to make the definition and computation of metrics simple, efficient and flexible.

The SLA computation engine 106 evaluates the Web service status data 108 against the SLAs set forth in the SLA definition database 104. In an example embodiment, the Web service status data 108 may be evaluated in accordance with the methods described in the co-pending patent application entitled, “DISPLAYING METRICS FROM AN ALTERNATIVE REPRESENTATION OF A DATABASE” by Casati et al., which was filed on Jan. 21, 2004, attorney docket number, 200310151-1, and is incorporated herein by reference.

Depending on the Web service, the service status data 108 may be centralized in a single database or distributed amongst several sites in several databases. Correlation of the status data between distributed stages of a composite Web service may be accomplished with the techniques described in the patent application Ser. No. 10/412,497 entitled, “Correlation of Web Service Interactions in Composite Web Services,” by Sayal et al., filed on Apr. 11, 2003, and incorporated herein by reference.

The aggregate data of SLA violations as determined from the Web service status data 108 is stored in a database of SLA violations 110. The database associates information such as the identifier of each process instance, the identifier of the metric underlying the SLA, and the value of the metric for the process instance.

Reporting tool 112 is available to report each individual SLA that has been violated along with the process instances that resulted in the violations. The reporting tool may display statistics such as the number of violations by type of Web service, by customer, by time or by another implementation-specific parameter.

SLA explanation and prediction tool 114 produces explanation and prediction models from the SLA violation information 110, Web service status data 108, and definitions 116 of a composite Web service. Explanation of SLA violations refers to communicating information about patterns found in the status data 108 of complete process instances that have violated SLAs. Prediction of an SLA violation refers to communicating information that indicates the likelihood that an active process instance will violate an SLA.

The explanation and prediction analyses may be performed using the SLA violation data 110, service status data 108, and definitions 116 of the composite Web services. The composite Web service definitions specify the behavior of the composite Web service, for example, the behavior of the composite Web service illustrated in FIG. 1.

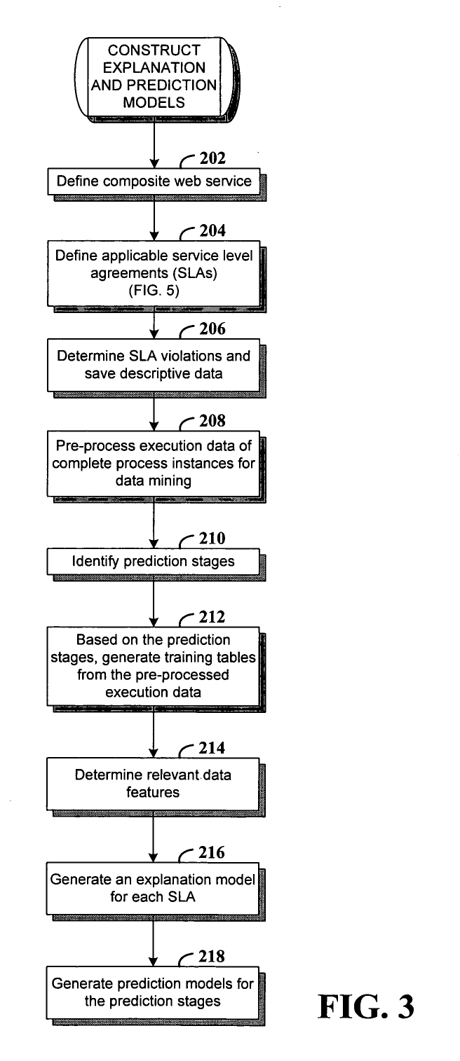

FIG. 3 is a flowchart of an example process for constructing an explanation model and one or more prediction models in accordance with various embodiments of the invention. The process generally entails generating an explanation model and one or more prediction models from the service status data and Web service definition. These models may then be used by a reporting tool to explain and predict behavior of process instances relative to the SLAs.

The composite Web services that are the subject of the explanation and prediction analysis are defined initially (step 202). Various commercially available or proprietary tools may be used to create a model of a Web service. In one tool, a graphical user interface (GUI) is provided. The GUI allows the model to be defined by way of user selection of icons available in the GUI to instantiate boxes and arcs, which represent nodes and data flow, respectively. The composite Web service definitions make visible the constituent Web service components of the composite Web service. The definitions describe the structure of the composite Web service, and status data corresponding to these definitions. For example, status data such as the starting time and the resource assigned for the execution of each node in the process flow may be described. The definitions thereby support generation of the explanation and prediction models from the status data.

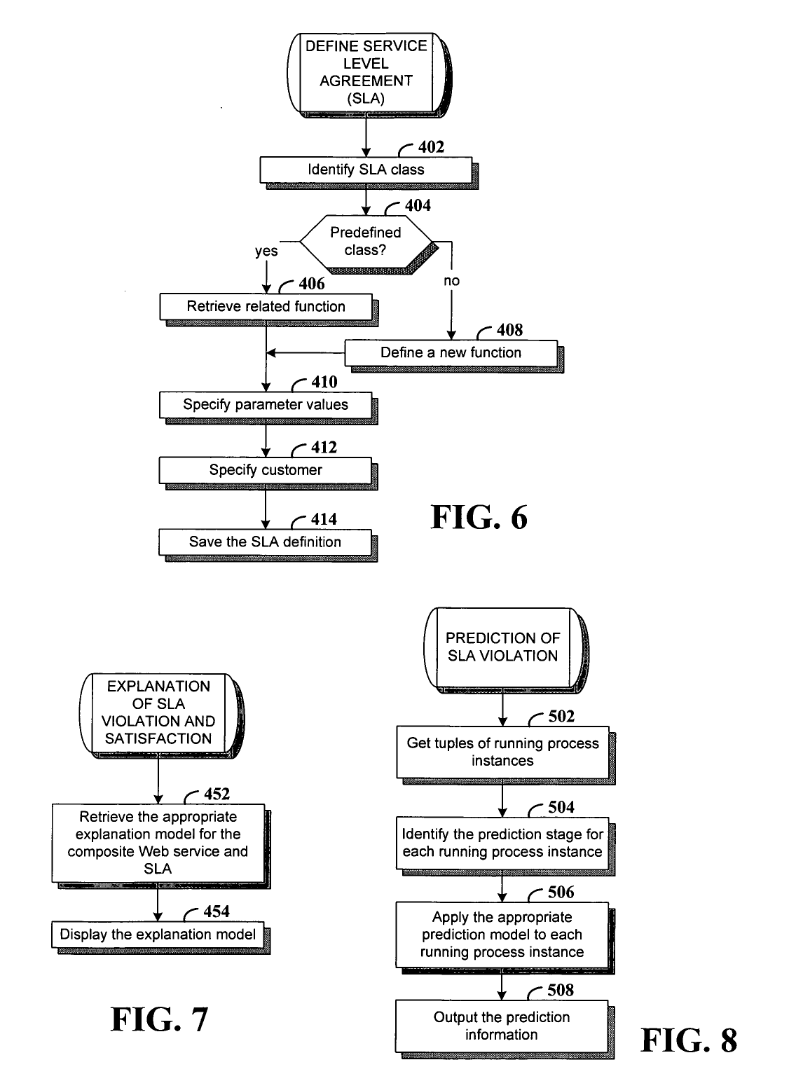

The analysis also requires a set of SLAs to be defined (step 204). An example process for defining SLAs is illustrated in FIG. 6. In one embodiment, the SLA definitions are stored in a database, where the type of database may be selected and structure defined according to implementation requirements.

The process instances that violated the defined SLAs are determined based on the status data associated with the process instances and the defined SLAs (step 206). As described above, the SLA violation data includes an association of the identifier of each process instance, an identifier for the metric, and the value of the metric for the process instance.

In an example embodiment, both the explanation model and the prediction models are decision trees. The intuitive structural description provided by a decision tree helps to explain what has been learned about SLA violations (i.e. patterns in the status data of process instances that have led to SLA violations in the past) and provide predictive information about which active process instances might fail the SLAs.

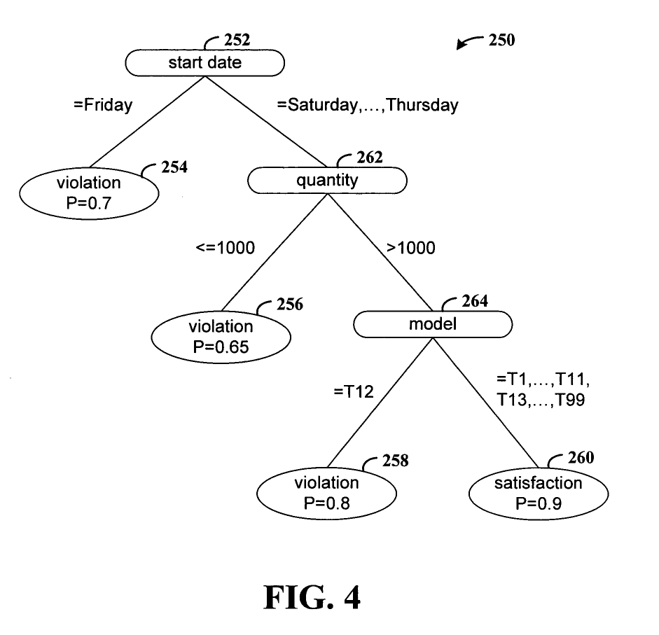

FIG. 4 is an example explanation model of the composite Web service of FIG. 1. The tree 250 illustrates the SLA violation patterns found in the status data associated with the buy_ties Web service. The example SLA is that the duration between the start_time of the receive order request stage 18 and the end_time of the send confirm shipment stage 32 must not exceed 48 hours.

A decision rule (corresponding to a pattern) may be obtained by traversing a branch of the tree from the root node 252 to one of leaves 254, 256, 258, and 260. Nodes 252, 262, and 264 represent process instance variables involved in the Web service, and each branch leading from a node, for example branch 266 represents a set of possible values associated with the variable of the node from which the branch emanates. Each of the leaves has an associated label value, either violation or satisfaction, and an associated probability level ranging from 0.0 to 1.0. An example decision rule obtained from the tree is that if an order is placed on Friday, there is a 0.7 probability that the SLA will be violated. Another example decision rule is that if an order is placed on Saturday through Thursday, for a quantity greater than or equal to 1000 ties, and the type of tie is T12, there is a 0.8 probability that the SLA will be violated.

The decision tree format allows a user to easily identify patterns of SLA violations which may assist in identifying a root cause. For example, a user may find that the reason that orders placed on Friday are likely to violate the SLA is because a majority of employees leave early on Friday. The user may suggest modifying work schedules or providing incentives for employees who stay longer to avoid the SLA violations.

The tree 250 exemplifies the models used for explanation and prediction of compliance with SLAs. For explanation, a tree is built for an SLA using the data generated during the execution of process instances, from beginning to end, along with the SLA violation data that indicates which process instances violated an SLA. For prediction, complete process instances are also used to build a tree because those are the ones whose final outcome (in terms of SLA compliance) is known. However, the prediction tree is constructed based only on status data that existed up to a certain execution stage of one or more process instances because a prediction model is generated for the purpose of predicting SLA outcome of active process instances that have advanced to a certain execution stage. As a process instance advances in its execution, the prediction models corresponding to more advanced execution stages are used to update the prediction. Also as the execution stage is more advanced, the confidence in the prediction grows. Thus, further processing of the status data is performed in preparation for constructing the prediction model(s). More than one prediction model may be created because a composite Web service includes multiple stages, and the present stage of a running process instance may be any of the possible stages.

Returning now to FIG. 3, steps 208, 210, 212, and 214 are further steps taken in preparation for generating a prediction/explanation model. At step 208, the status data of complete process instances is preprocessed and horizontalized for application of data mining processes. Typically, only complete process instances are considered for the purpose of generating prediction models. In data mining applications, the preprocessing and horizontalization of data is sometimes referred to as creating a training set. Creation of the training set is described in the following paragraphs.

Status data related to each process instance may be stored in different tables, and the stages through which each process instance flows may differ from one process instance to the next. An example of the different possible stages is illustrated by the decision points in the process flow of FIG. 1. Furthermore, cycles may exist where a stage is executed more than once for the same process instance. The preprocessing and horizontalization of the status data prepares the data for application of selected data mining techniques.

Data mining techniques generally require one record per training instance with each record being of the same length. The preprocessing involves obtaining the status data associated with process instances that have completed. Horizontalization refers to selecting relevant attributes from the obtained status data and storing the attribute values for each process instance in a single record. The selection of relevant attributes may be performed using generally known or proprietary techniques, depending on implementation requirements.

Turning now to generating prediction models, a prediction model is based on a selected prediction stage. A prediction stage corresponds to a stage in the Web service execution in which prediction information may provide a meaningful indication as to whether a running process instance that has reached that prediction stage will violate or satisfy a given SLA. Generally, a prediction stage references a stage that has been completed by a running process instance.

There may be multiple prediction stages with each prediction stage having a corresponding prediction model. Some stages may be less useful as a prediction stage than other stages. For example, in the process flow of FIG. 1, the status data associated with the receive quote request stage 12, such as the day on which the quote was received, may be more useful in predicting violations of an SLA than information associated with the invoke quote stage 14. The prediction stages may be identified either by user specification or by automatically identifying the stages using the service status data (step 210).

Once the prediction stages are identified, training tables are generated (step 212) from the data obtained in step 210. A training table is created for each identified prediction stage. A training table generated for explanation is assembled from the status data of completed process instances from the beginning to the end of execution (all the data in the training set from step 208). A training table generated for a prediction stage is assembled from data of completed process instances that was generated from the beginning of each process instance (i.e., start stage) up to the last stage (activity) corresponding to that prediction stage (a subset of the training set from step 208) and following a given path.

The effectiveness of the prediction models may depend largely on whether the attributes associated with each process instance are relevant and unique. That is, some attributes may be irrelevant, redundant, or noisy in terms of predicting whether a process instance will violate an SLA. Determining relevant data features (step 214) involves identifying and removing as much of the irrelevant and redundant information as possible as well as deriving new features from relevant, existing ones. Feature selection reduces the dimensionality of the training tables, thereby reducing the size of the hypothesis space and allowing data mining processes to operate faster and more effectively.

In an example embodiment, a correlation-based feature selection technique is used to determine the relevant data features. Correlation-based feature selection handles both discrete and continuous features and discrete and continuous classification problems. Correlation-based feature selection generally rests on the principle that the features in a good set of features are highly correlated with the class and are uncorrelated with each other. The class in this application is the violation/satisfaction of an SLA. Various known processes may be implemented for performing the correlation-based feature selection.

New features may also be derived from the status data. An example may be the number of times each a stage is executed for each process instance. In another example, it may be beneficial to break a timestamp feature into additional features such as day of week, day of the month, week of the month, or month of the year. In another embodiment, features may be manually selected based on experience with the Web service. The correlation-based feature selection process may then be performed on the data with the user defined features.

Once the relevant features have been determined and the training tables appropriately configured, the process continues by generating an explanation model for each SLA (step 216) and one or more prediction models for the identified prediction stages (step 218).

In one embodiment, the explanation model for an SLA is an explanatory decision tree. An example explanatory decision tree of the Web service 10 of FIG. 1 is illustrated in FIG. 4. Various algorithms are available to generate the decision tree, and examples include the algorithms known in the art as C4.5, CART, and Sprint. The explanation model may be stored using various data structures suitable for storing information in a graph having nodes and edges.

A prediction model is generated for each of the prediction stages (step 218) identified in step 210. For each prediction model, the training table generated for the corresponding prediction stage is used to generate the model. Similar to generating the explanation model, each prediction model is a decision tree and various algorithms are available to generate the decision tree.

A user may then use the explanation model from step 216 and prediction models from step 218 to evaluate the conformance of the Web service to the various SLAs and monitor running process instances.

The decision tree 250 of FIG. 4 may also be viewed as an example of a decision tree associated with a prediction stage that corresponds to the initial stage 12 of FIG. 1. It may be observed that in generating decision tree 250 for a prediction stage at stage 12, status data such as whether the requested item is in stock, is unknown. Therefore, the status data occurring after the prediction stage is excluded in generating the decision tree.

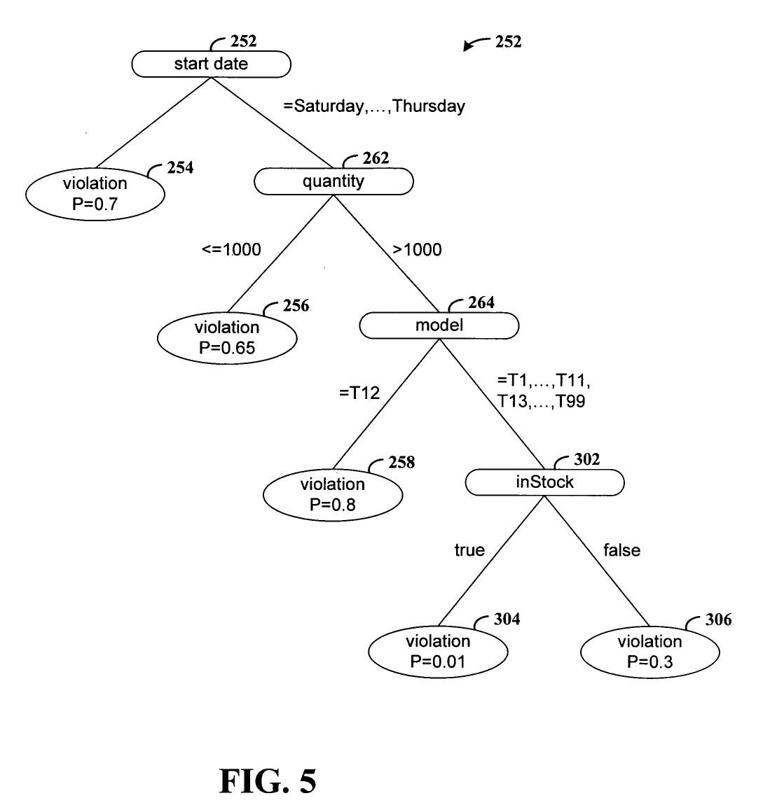

FIG. 5 illustrates another example decision tree 252 based on an example prediction stage of the composite Web service 10 of FIG. 1. The example prediction stage corresponds to stage 22 of the composite Web service. At stage 22, it is known whether the requested ties are in stock (node 302). If the ties are in stock, the probability of an SLA violation is 0.01 (node 304). If the ties are out of stock, the probability of an SLA. violation is 0.3. It will be appreciated that decision tree 252 does not include nodes for process instance attributes having values derived from the status data logged after stage 22.

FIG. 6 is a flowchart of an example process for defining SLAs in accordance with various embodiments of the invention. Assistance may be provided to a user by presenting, by way of a graphical user interface, for example, a set of possible classes of SLAs for which parameterizable functions are available to implement the SLA. The user may select one of the available classes or specify a new class (step 402).

If a predefined class is selected (decision step 404), a function associated with the class is selected from a library of functions. Otherwise, the user may codify a new function to add to the library (step 408).

In either case, parameter values are obtained from the user for use by the selected function (step 410). For example, as previously described the parameter values may indicate a time interval, a quantity of an item, a product identifier or other application-specific characteristic. The parameter values are used by the function to evaluate whether a process instance violates or satisfies the SLA implemented by the function.

Because SLAs may generally be viewed as an agreement between a provider and a specific customer, the function may further be parameterized by a customer identifier (step 412). This limits applicability of the SLA definition to only the designated customer. The SLA definition may then be saved for use in determining whether process instances have complied with or violated the SLA.

FIG. 7 is a flowchart of an example process for explaining violations and satisfactions of an SLA for completed process instances in accordance with various embodiments of the invention. This process may be invoked once an explanation model has been created as described in the description of FIG. 3. It may be preferable to create the model off line, for example with a background process. Presenting the model to a user to provide explanations may be done on line and therefore, in real time.

In explaining the process instances that violated or satisfied an SLA, the process first obtains the explanation model associated with a selected SLA (step 452). The SLA may be selected by a user via a GUI of a reporting tool. The reporting tool may then display the explanation model in a format that illustrates the nodes and edges of the decision tree (step 454). For example, the model may be displayed as a graph image of the nodes, edges, and leaves in the decision tree or as a list of decision rules corresponding to the different paths from the root of the tree to each of the leaves.

FIG. 8 is a flowchart of an example process for predicting a violation of an SLA in accordance with various embodiments of the invention. The process begins by obtaining the tuples of the running process instances (step 502). The tuples of the process instances are read from the service status data 108 and the information includes all status data associated with the running process instances. The tuples are horizontalized so that a single record is created for each process instance.

Next, the appropriate prediction stage of each running process instance is identified using the information gathered in the single record for the process instance. The prediction stage for a process instance may be determined based on the current state of the process instance. For example in reference to the example Web service of FIG. 1, if the current state of a process instance indicates that the process instance is checking the stock in stage 20 and a prediction stage is associated with completion of stage 18, then the prediction stage for the process instance is the prediction stage that is defined for stage 18 if there are no prediction stages for the stages between stages 18 and 20 (including 20). Generally, if there is no prediction stage for the current stage of an active process instance, the nearest prediction stage before the current stage is the prediction stage for the process instance.

The prediction model associated with the prediction stage identified for a process instance is then applied to the process instance (step 506). The application of the appropriate prediction model is performed for each active process instance. In applying a process instance to a prediction model (the prediction model is a decision tree), the process traces the decision tree using attribute values associated with the process instance until a leaf node is encountered. The probability value associated with the leaf node indicates the probability that the process instance will violate the SLA.

The prediction information may then be output to a user for each running process instance (step 508). The prediction information may include information such as the identifier of each process instance, all the attribute values of the process instance, and the probability that the process instance will violate the SLA.

Those skilled in the art will appreciate that various alternative computing arrangements would be suitable for hosting the processes of the different embodiments of the present invention. In addition, the processes may be provided via a variety of computer-readable media or delivery channels such as magnetic or optical disks or tapes, electronic storage devices, or as application services over a network.

The present invention is believed to be applicable to a variety of systems for managing SLAs and has been found to be particularly applicable and beneficial in reporting probabilities that SLAs will be violated and to understand in which situations SLAs may be violated. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

1. A method for managing at least one service level agreement (SLA) associated with at least one composite Web service, comprising:
defining a service level agreement (SLA) that includes a set of criteria;
determining from status data logged during execution of each completed process instance of a composite Web service whether the process instance satisfied the criteria of the SLA;
storing a first data set that identifies the process instances and indicates for each process instance whether the process instance satisfied the criteria of each SLA;
constructing an explanatory decision tree from the status data and the first data set, wherein each node in the explanatory decision tree represents at least one attribute of the process instances, each branch from a node represents a subset of attribute values of the attribute of the node, and each leaf node indicates a probability value that process instances having attribute values consistent with the attribute values in nodes on a path to the leaf node fail to satisfy the criteria of the SLA; and
outputting data that represents the explanatory decision tree.

2. The method of claim 1, wherein the composite Web service includes a plurality of stages, the method further comprising:
selecting a second data set from the logged status data, wherein the second data set includes status data logged up to a selected stage of the composite Web service for the process instances identified in the first data set;
constructing a predictive decision tree from the second data set wherein each node in the predictive decision tree represents at least one attribute of the process instances, each branch from a node represents a subset of attribute values of the attribute of the node, and each leaf node indicates a probability value that process instances having attribute values consistent with the attribute values in nodes on a path to the leaf node fail to satisfy the criteria of the SLA;
determining for each active process instance using the predictive decision tree and attributes of the active process instance, whether the process instance is predicted to violate criteria of an SLA; and
outputting, for each process instance predicted to violate criteria of an SLA, data that identifies the process instance and SLA.

3. The method of claim 2, further comprising:
for each of a selected plurality of the stages of the Web service, selecting respectively associated subsets of data from the logged status data, wherein each subset includes status data logged up to the associated stage of the composite Web service for the process instances identified in the first data set;
constructing respectively associated predictive decision trees from the subsets of data associated with the selected plurality of stages;
determining for each active process instance using each predictive decision tree and attributes of the active process instance, whether the process instance is predicted to violate criteria of an SLA; and
outputting, for each process instance predicted to violate criteria of an SLA, data that identifies the process instance and SLA.

4. The method of claim 3, further comprising outputting, for each process instance predicted to violate criteria of an SLA, data that indicates a relative probability that the process instance will violate criteria of the SLA.

5. The method of claim 3, further comprising:
selecting attributes having values that correlate to an SLA violation;
wherein the step of selecting subsets of logged status data includes selecting a subset that includes the attributes and values from the step of selecting attributes; and
using the subset of the logged status data in constructing each predictive decision tree.

6. The method of claim 1, further comprising:
selecting attributes having values that correlate to an SLA violation;
selecting a subset of the logged status data, wherein the subset includes the attributes and values from the step of selecting attributes; and
using the subset of the logged status data in constructing the explanatory decision tree.

7. The method of claim 1, wherein the output data that represents the explanatory decision tree is graph data with each node being a two-dimensional object, and branches connecting the nodes represented being lines.

8. The method of claim 1, wherein the output data that represents the explanatory decision tree is a text-based description of attributes and values of attributes in paths in the tree.

9. An apparatus for managing at least one service level agreement (SLA) associated with at least one composite Web service, comprising:
means for defining a service level agreement (SLA) that includes a set of criteria;
means for determining from status data logged during execution of each completed process instance of a composite Web service whether the process instance satisfied the criteria of the SLA;
means for storing a first data set that identifies the process instances and indicates for each process instance whether the process instance satisfied the criteria of each SLA;
means for constructing a explanatory decision tree from the logged status data and the first data set, wherein each node in the explanatory decision tree represents at least one attribute of the process instances, each branch from a node represents a subset of attribute values of the attribute of the node, and each leaf node indicates a probability value that process instances having attribute values consistent with the attribute values in nodes on a path to the leaf node fail to satisfy criteria of the SLA; and
means for outputting data that represents the explanatory decision tree.

10. The apparatus of claim 9, wherein the composite Web service includes a plurality of stages, further comprising:
means for selecting a second data set from the logged status data, wherein the second data set includes status data logged up to a selected stage of the composite Web service for the process instances identified in the first data set;
means for constructing a predictive decision tree from the second data set wherein each node in the predictive decision tree represents at least one attribute of the process instances, each branch from a node represents a subset of attribute values of the attribute of the node, and each leaf node indicates a probability value that process instances having attribute values consistent with the attribute values in nodes on a path to the leaf node fail to satisfy criteria of the SLA;
means for determining for each active process instance using the predictive decision tree and attributes of the active process instance, whether the process instance is predicted to violate criteria of an SLA; and
means for outputting, for each process instance predicted to violate criteria of an SLA, data that identifies the process instance and SLA.

11. The apparatus of claim 10, further comprising means for outputting, for each process instance predicted to violate criteria of an SLA, data that indicates a relative probability that the process instance will violate criteria of the SLA.

12. The apparatus of claim 10, further comprising:
means for selecting attributes having values that correlate to an SLA violation;
means for selecting a subset that includes the attributes and values from the selected attributes; and
means for constructing each predictive decision tree using the subset of the logged status data.

13. The apparatus method of claim 9, further comprising:
means for selecting attributes having values that correlate to an SLA violation;
means for selecting a subset of the logged status data, wherein the subset includes the attributes and values from the step of selecting attributes; and
means for constructing the explanatory decision tree using the subset of the logged status data.

14. An article of manufacture for managing at least one service level agreement (SLA) associated with at least one composite Web service, comprising:
a processor-readable medium configured with instructions for causing the processor to perform the steps of,
defining a service level agreement (SLA) that includes a set of critera;
determining from status data logged during execution of each completed process instance of a composite Web service whether the process instance satisfied the criteria of the SLA;
storing a first data set that identifies the process instances and indicates for each process instance whether the process instance satisfied criteria of each SLA;
constructing a explanatory decision tree from the logged statusdata and the first data set, wherein each node in the explanatory decision tree represents at least one attribute of the process instances, each branch from a node represents a subset of attribute values of the attribute of the node, and each leaf node indicates a probability value that process instances having attribute values consistent with the attribute values in nodes on a path to the leaf node fail to satisfy criteria of the SLA; and
outputting data that represents the explanatory decision tree.

15. The article of manufacture of claim 14, wherein the composite Web service includes a plurality of stages, and the processor-readable medium is further configured with instructions for causing the processor to perform the steps of,
selecting a second data set from the logged status data, wherein the second data set includes status data logged up to a selected stage of the composite Web service for the process instances identified in the first data set;
constructing a predictive decision tree from the second data set wherein each node in the predictive decision tree represents at least one attribute of the process instances, each branch from a node represents a subset of attribute values of the attribute of the node, and each leaf node indicates a probability value that process instances having attribute values consistent with the attribute values in nodes on a path to the leaf node fail to satisfy criteria of the SLA;
determining for each active process instance using the predictive decision tree and attributes of the active process instance, whether the process instance is predicted to violate criteria of an SLA; and
outputting, for each process instance predicted to violate criteria of an SLA, data that identifies the process instance and SLA.

16. The article of manufacture of claim 15, wherein the processor-readable medium is further configured with instructions for causing the processor to perform the steps of:
for each of a selected plurality of the stages of the Web service, selecting respectively associated subsets of data from the logged status data, wherein each subset includes status data logged up to the associated stage of the composite Web service for the process instances identified in the first data set;
constructing respectively associated predictive decision trees from the subsets of data associated with the selected plurality of stages;
determining for each active process instance using each predictive decision tree and attributes of the active process instance, whether the process instance is predicted to violate criteria of an SLA; and
outputting, for each process instance predicted to violate criteria of an SLA, data that identifies the process instance and SLA.

17. The article of manufacture of claim 16, wherein the processor-readable medium is further configured with instructions for causing the processor to perform the step of outputting, for each process instance predicted to violate criteria of an SLA, data that indicates a relative probability that the process instance will violate criteria of the SLA.

18. The article of manufacture of claim 16, wherein the processor-readable medium is further configured with instructions for causing the processor to perform the steps of:
selecting attributes having values that correlate to an SLA violation;
wherein the step of selecting subsets of logged status data includes selecting a subset that includes the attributes and values from the step of selecting attributes; and
using the subset of the logged status data in constructing each predictive decision tree.

19. The article of manufacture of claim 14, wherein the processor-readable medium is further configured with instructions for causing the processor to perform the steps of:
selecting attributes having values that correlate to an SLA violation;
selecting a subset of the logged status data, wherein the subset includes the attributes and values from the step of selecting attributes; and
using the subset of the logged status data in constructing the explanatory decision tree.

20. The article of manufacture of claim 14, wherein the output data that represents the explanatory decision tree is graph data with each node being a two-dimensional object, and branches connecting the nodes represented being lines.

21. The article of manufacture of claim 14, wherein the output data that represents the explanatory decision tree is a text-based description of attributes and values of attributes in paths in the tree.
